(19) United States
(12) Patent Application Publication
(10) Pub. No.: US 2006/0034521 A1
(43) Pub. Date: Feb. 16, 2006

(54) Computer program product and method for analysis of medical image data in a medical imaging system

(75) Inventors: Hanna Lindmark, Linkoping (SE); Aron Ernvik, Linkoping (SE); Magnus Bjorklund, Linkoping (SE); Qingfen Lin, Linkoping (SE); Magnus Ranlof, Linkoping (SE)

Correspondence Address: VENABLE LLP, P.O. BOX 34385, WASHINGTON, DC, 20045-9998, US

(73) Assignee: SECTRA IMTEC AB, LINKOPING (SE)

(21) Appl. No.: 10/892,369

(22) Filed: Jul. 16, 2004

(51) Int. Cl. G06K 9/36

(52) U.S. Cl. 382/232

(57) ABSTRACT

The present invention relates to a computer program product for analysis of a source medical image data set in a medical imaging system, being operable to: identify a user identity; identify at least one role linked to the user identity; load a source medical image data set; allow the user to review the loaded source medical image data set; allow the user to, based on role privileges, interactively perform processing operations on the loaded source medical image data set; create a processing protocol; allow the user to interactively specify at least one medical image data set characteristic to be associated with a processing protocol associater; allow the user to interactively restrict which user(s) to be associated with a user access right of the processing protocol by specifying which role(s) or which user identity/identities to be associated with the user access right; allow the user to interactively further restrict the role privileges; store the processing protocol in a central unit, and, if the user is associated with a user access right of a stored processing protocol, reload the stored processing protocol; allow the user to interactively choose the processing protocol for application, and apply the stored processing protocol.

### FIELD OF THE INVENTION

The present invention generally relates to medical imaging, and in particular but not exclusively to a computer program product and a method for analysis of a source medical image data set in a medical imaging system.

### BACKGROUND OF THE INVENTION

Medical imaging is a very important tool within the field of medicine, since it may be used for creation and analysis of medical images of an interior region of a body of a patient. Doctors and other medical personnel may use medical imaging in different stages of medical procedures such as diagnosis of, for example, injuries, diseases and abnormal conditions, surgery planning, treatment and postoperative evaluation. Medical imaging allows not only that examination of the interior of a living body may be performed, but also that decisions in medical procedures may be made more easily and correctly.

Medical imaging equipment may include data acquisition devices and/or workstations for analysis of acquired data. Most of the medical imaging systems used today include both at least one data acquisition device and at least one analysis workstation. Furthermore, medical imaging systems may also include a system for storing and communicating medical image data, such as picture archiving and communication system (PACS).

The data acquisition devices in medical imaging systems are used for collecting medical image data and may be based on a variety of acquisition techniques, such as computerized tomography (CT), nuclear magnetic resonance (NMR), magnetic resonance imaging (MRI), ultrasound, X-ray angiography and positron emission tomography (PET). Many devices utilizing such techniques provide data for hundreds of medical images per study, which is highly valuable from a diagnostic point of view.

Analysis workstations of different types are used in medical imaging systems for interpretation, manipulation and visualization of previously acquired medical image data. However, such workstations are usually based on highly sophisticated computer program products, and are thus often complex to operate. Computer program product manufacturers strive to develop computer program products that are as user-friendly and efficient as possible, but a user often still needs to perform operations and adjustments of settings that are numerous and complex when analysing a particular medical image data set during an analysis work process. The operations may for example be setting a proper color scheme to enhance the view of a specific organ, finding proper multi-planar reformatting (MPR) parameters to expose pathologic areas, clipping away anatomy that occludes the target area and performing various measurements in the data set to provide quantitative information.

Since the operations that have to be performed often are numerous and complex, it may, even for a skilled user, be rather time-consuming to generate an appropriate representation of a particular data set. Furthermore, the analysis work process during which operations are performed is at least partially subjective, whereby it may be difficult for a user to perform exactly the same operations on specific medical image data at different times. Thus, in order to avoid performing repetitive work and performing different operations on specific medical image data at different times, it is highly desirable to save operations and settings during and after an analysis work process.

WO 03/046794 discloses a computer program product and a method for performing the steps of: loading a source data set for manipulation; generating and displaying image data of the source data set by allowing user adjustment of operational state conditions, and storing image data of a displayed image together with operational state data (data associated with performed settings and operations). The image data may be stored in a way conforming to the network standard, e.g. as a DICOM (Digital Imaging and Communications in Medicine) file. The operational state data may be stored as a supplementary DICOM file and be associated with the image data by adding an entry in the header of the image data file. In other embodiments, the operational state data may be stored in multiple supplementary DICOM files or be fitted as a whole in the header of the image data file. Operational state data contained in supplementary files may be applied on a different source data set.

One drawback of the computer program product and method according to WO 03/046794 is the occupation of data storage resources through the storing of generated and displayed image data of a source data set together with operational state data. Especially the storage of generated image data implies an additional load on a medical imaging system in which the computer program product is utilized.

Another drawback of the computer program product and method according to WO 03/046794 is that there are no restrictions utilized regarding which types of settings and operations a certain user is entitled to make. Furthermore, there are no restrictions on a certain user regarding performance of settings and operations in association with previously saved settings and operations. The lack of such restrictions implies that there may exist a big risk that incorrect settings and operations are made by users not having required knowledge for making certain settings and operations. In order to be able to make correct settings and operations, a user must both have sufficient knowledge of analyzing source medical image data sets and of operating the computer program product used for making settings and operations during analysis. If incorrect settings and operations are made, it may of course result in interpretation of a data set and, thus, incorrect diagnosis etc.

Still another drawback of the computer program product and method according to WO 03/046794 is that there is no functionality implemented for restricting which source data sets saved information regarding operations and settings may be used on. As mentioned above, operational state data contained in supplementary files according to WO 03/046794 may be applied on a different data set than the data set that it was elaborated on, but there are no restrictions implemented on which different data sets the operational state data contained in the supplementary files may be applied on. If saved information regarding operations and settings is used wrongly, i.e. on source data sets which the information is not suitable for, it may lead to wrong interpretations of a data set and, thus, incorrect diagnosis.

Thus, there is a need for a simple way of achieving the ability to store settings and operations associated with medical image representations generated from a source data set in a medical imaging system without the necessity to store the generated image data and the ability to achieve a high reliability of analysis of source medical image data sets.

### SUMMARY OF THE INVENTION

Accordingly, it is an object of preferred embodiments of the present invention to provide an improved computer program product that provides for saving of data storage resources in association with storage of settings and operations performed on source medical image data sets and to provide high reliability of analysis of source medical image data sets.

This object may be achieved through a computer program product for analysis of a source medical image data set in a medical imaging system, the computer program product being operable to: (a) identify a user identity of a user; (b) identify at least one role being linked to the user identity from a list of a plurality of roles, each role being associated with a specification of role privileges of performing processing operations on a source medical image data set; (c) load a source medical image data set into an analysis workstation in the medical imaging system; (d) allow the user to review the loaded source medical image data set; (e) allow the user to, based on the role privileges, interactively perform processing operations on the loaded source medical image data set; (f) create a processing protocol including at least one processing parameter set corresponding to at least a subset of processing operations performed on the loaded source medical image data set; (g) allow the user to interactively specify at least one medical image data set characteristic to be associated with a processing protocol associater in the processing protocol, the processing protocol being associated with each source medical image data set having at least one of the at least one specified medical image data set characteristic; (h) allow the user to interactively restrict which user(s) to be associated with a user access right of the processing protocol by specifying which role(s) or which user identity/identities to be associated with the user access right; (i) allow the user to interactively further restrict the role privileges of performing processing operations, which further restricted role privileges are to be applied in association with the processing protocol; (j) store the processing protocol in a central unit in the medical imaging system, and if the user is associated with a user access right of a stored processing protocol associated with the loaded source medical image data set, (k) reload the stored processing protocol into an analysis workstation in the medical imaging system; (l) allow the user to interactively choose the processing protocol for application on the loaded source medical image data set, and (m) apply the stored processing protocol on the loaded source medical image data set.

Another object of preferred embodiments of the preset invention is provide an improved method that provides for saving of data storage resources in association with storage of settings and operations performed on source medical image data sets and to provide high reliability of analysis of source medical image data sets.

This object may be achieved through a method for analysis of a source medical image data set in a medical imaging system, the method including: (a) identifying a user identity of a user; (b) identifying at least one role being linked to the user identity from a list of a plurality of roles, each role being associated with a specification of role privileges of performing processing operations on a source medical image data set; (c) loading a source medical image data set into an analysis workstation in the medical imaging system; (d) allowing the user to review the loaded source medical image data set; (e) allowing the user to, based on the role privileges, interactively perform processing operations on the loaded source medical image data set; (f) creating a processing protocol that includes at least one processing parameter set corresponding to at least a subset of processing operations performed on the loaded source medical image data set; (g) allowing the user to interactively specify at least one medical image data set characteristic to be associated with a processing protocol associater in the processing protocol, the processing protocol being associated with each source medical image data set having at least one of the at least one specified medical image data set characteristic; (h) allowing the user to interactively restrict which user(s) to be associated with a user access right of the processing protocol by specifying which role(s) or which user identity/identities to be associated with the user access right; (i) allowing the user to interactively further restrict the role privileges of performing processing operations, which further restricted role privileges are to be applied in association with the processing protocol; (j) storing the processing protocol in a central unit in the medical imaging system, and if the user is associated with a user access right of a stored processing protocol associated with the loaded source medical image data set, (k) reloading the stored processing protocol into an analysis workstation in the medical imaging system; (l) allowing the user to interactively choose the processing protocol for application on the loaded source medical image data set, and (m) applying the stored processing protocol on the loaded source medical image data set.

One advantage of the computer program product and method according to preferred embodiments of the present invention is the possibility to specify which source medical image data set(s) that an elaborated processing protocol may be applied on based on unique identities of the source medical image data set(s) or based on the type of the source medical image data set(s), specify one or a plurality of user(s) that is/are entitled to use the processing protocol based on user identities or roles and further restrict the privileges of users of performing processing work on a source medical image data set to be applied when the processing protocol is used. This possibility implies not only that many functionalities may be combined in one computer program product, but also that sources or error during analysis work processes may be minimized. A further advantage is the possibility to save storage resources by the possibility to restore a previous elaborated medical image representation of a source medical image data set without the necessity to store the elaborated representation. Still another advantage is the possibility to store an elaborated processing protocol centrally within a medical imaging system.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention will in the following be described in more detail with reference to the accompanying drawings, in which

FIG. 1 is a schematic view of a medical imaging system, which is an exemplar of a medical imaging system in which the invention may be used.

FIG. 2 is a flow diagram representing a process which a computer program product according to a preferred embodiment of the invention is operable to perform,

FIG. 3 is a screen shot of a display of a 2D image generated from a 3D source medical image data set,

FIG. 4 is a flow diagram representing a data set specific and user specific application according to one embodiment of the present invention.

FIG. 5 is a flow diagram representing a data set specific and role specific application according to one embodiment of the present invention.

FIG. 6 is a flow diagram representing a data type specific and user specific application according to one embodiment of the present invention.

FIG. 7 is a flow diagram representing a data type specific and role specific application according to one embodiment of the present invention.

### DETAILED DESCRIPTION OF EMBODIMENTS

The computer program product and method according to the present invention are intended to be used in a medical imaging system for analysis of medical image data. Such a medical imaging system may include one or several types of medical imaging components in a care institution, such as a hospital. Examples of different types of medical imaging components are a data acquisition device, an analysis workstation, a file server and a file archive. Furthermore, such a medical imaging system may include more than one medical imaging component of one type, i.e. for example more than one data acquisition device, and may also include more than one care institution. Embodiments of the present invention will be described hereinafter in the context of a computer program product and a method. Some of the embodiments are described in terms of a computer program product that causes a single computer in a medical imaging system to provide the desired functionality of the present invention, but the computer program product may also be implemented in a medical imaging system to cause several computers to provide the desired functionality of the present invention.

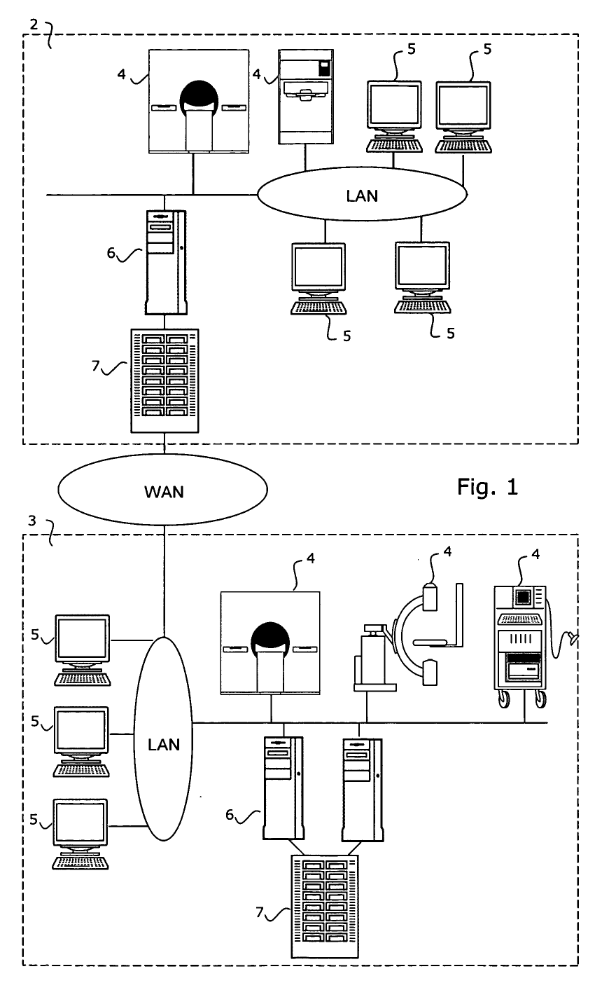

FIG. 1 is a schematic view of an embodiment of a medical imaging system 1, which is an exemplar of a medical imaging system in which the invention may be used. The medical imaging system 1 is a network including two hospitals and includes a first hospital component 2 and a second hospital component 3. Each of the hospital components 2, 3 includes a plurality of data acquisition devices 4, a plurality of analysis workstations 5, at least one file server 6 and at least on file archive 7. Furthermore, preferably the medical imaging system 1 includes a system designed to store and communicate digital image data within a medical imaging system such as a picture archiving and communication system (PACS).

The data acquisition device 4 may be used for collection of medical image data representing an interior region of a body of at patient. For example, the data acquisition device 4 may be a device based on any of the acquisition techniques in the group of computerized tomography (CT), nuclear magnetic resonance (NMR), magnetic resonance imaging (MRI), ultrasound, X-ray angiography and positron emission tomography (PET). Furthermore, the data acquisition devices 4 in the medical imaging system 1 may be of different types.

The medical imaging system 1 is preferably configured to transmit data in a standardised common data format. Currently, the preferred image data format within the field of medical imaging is the “Digital Imaging and Communications in Medicine” (DICOM) format. DICOM provides a well-defined and accepted data format and interaction protocol for communicating medical image data. The DICOM standard is maintained and extended by an international multi-speciality committee, which consists of biomedical professional organizations, companies, vendor associations, government agencies etc.

Each acquired source medical image data set is preferably assigned a unique identifier for identification, such as a unique identification number in a conventional way. A medical image data set acquired during an acquisition process, stored as a DICOM-file and assigned a unique identifier is herein termed “source medical image data set”. The source medical image data set may be a volume data set, i.e. a 3-D data set, or a data set of higher or lower dimensionality.

The analysis workstation 5 may be of any conventional type and is used for interpretation, manipulation and visualization of previously acquired source medical image data sets. The file server 6 may include a general purpose network file server. The file archive 7 may include a magnetic, optical or other long term storage medium. In each hospital component 2, 3, all of the medical imaging components are interconnected by a local area network (LAN). The local area networks in the two hospital components 2, 3 are interconnected by a wide area network (WAN) through gateways (not shown).

Furthermore, as shown in FIG. 1, the acquisition devices 4 and analysis workstations 5 in the medical imaging system 1 may all be separate entities. However, in an alternative the medical imaging system 1 may include at least one separate analysis workstation 5 and at least one analysis workstation 5 being integrated into any of the acquisition devices 4 in the medical imaging system 1. In a further alternative, each analysis workstation 5 included in the medical imaging system 1 may be integrated into any of the acquisition devices 4 in the medical imaging system 1.

A source medical image data set collected by one of the data acquisition devices 4 in any of the hospital components 2, 3 may be transferred over the local area network in the hospital component 2, 3 in which it was acquired to a file server 6 for storage in a file archive 7 or may be transferred over the wide area network to a file server 6 in the other hospital component 2, 3 for storage in a file archive 7 there. The stored source medical image data set may then later be loaded using the unique identifier to any of the analysis workstations 5 in the same hospital component 2, 3 as it was stored in or to any of the analysis workstations 5 within the other hospital component 2, 3 for further processing. However, a collected source medical image data set may of course also be transferred directly after acquisition, i.e. before storage in a file archive 7, to any analysis workstation 5 within the medical imaging system 1 for further processing.

In an alternative embodiment of the medical imaging system 1, there is only one hospital component 2, 3 and thus only one local area network as well as no wide area network. In a further alternative embodiment of the medical imaging system 1, there are more than two hospital components 2, 3.

One or a plurality of computer program products that causes computers to provide specific functionalities may be implemented either in one analysis workstation 5 or in several analysis workstations 5 in the medical imaging system 1. The computer program product according to the present invention may be one of the computer program products that are implemented either in one analysis workstation 5 or in several analysis workstations 5 in the medical imaging system 1.

In order to prevent unauthorized persons from using the medical imaging system 1, a user login process may preferably be implemented in the medical imaging system 1. Each person being entitled to enter into the medical imaging system 1 and use any of the medical imaging components therein is then, in a conventional way, assigned a unique user identity and a password to be used for entry into the medical imaging system 1.

Furthermore, each user identity is preferably linked to at least one of a plurality of roles listed in a database being implemented in the medical imaging system 1. Examples of such roles are technician, radiologist, and clinician. There may also be subgroups of the different roles. For example, there may be subgroups of the clinician role, such as orthopedist or neurosurgeon. Each role may be associated with a specification of role privileges of, for example, performing processing operations on a source medical image data set. The specification of role privileges of performing processing operations on a source medical image data set is a specification of which processing operation(s) a user identity being linked to the role is entitled to perform. Each role may be entitled to perform none, one or several processing operations and different roles may of course be entitled to perform different numbers and types of processing operations. As will be described in more detail below, examples of processing operations are setting viewing direction, setting a color scheme, setting multi-planar reformatting parameters, measurement, clipping, cropping, sculpting, setting of graphical user interface, storing medical image data sets and inserting annotation. Computer program products which are intended to be implemented at one or several analysis workstations 5 and which cause the analysis workstation(s) 5 to provide the functionality of performance of such processing operations as mentioned above are well-known and are intended to be used in association with the computer program product according to the present invention.

Furthermore, as stated above, each user identity may be linked to at least one role and, thus, a user identity may be linked to one role or to several roles. The number of roles that a user identity is linked to depends on the knowledge and competence of the user. For example, a user identity may be linked to both the technician role and the radiologist role if the user being assigned the user identity has knowledge and competence to perform the tasks of both a technician and a radiologist.

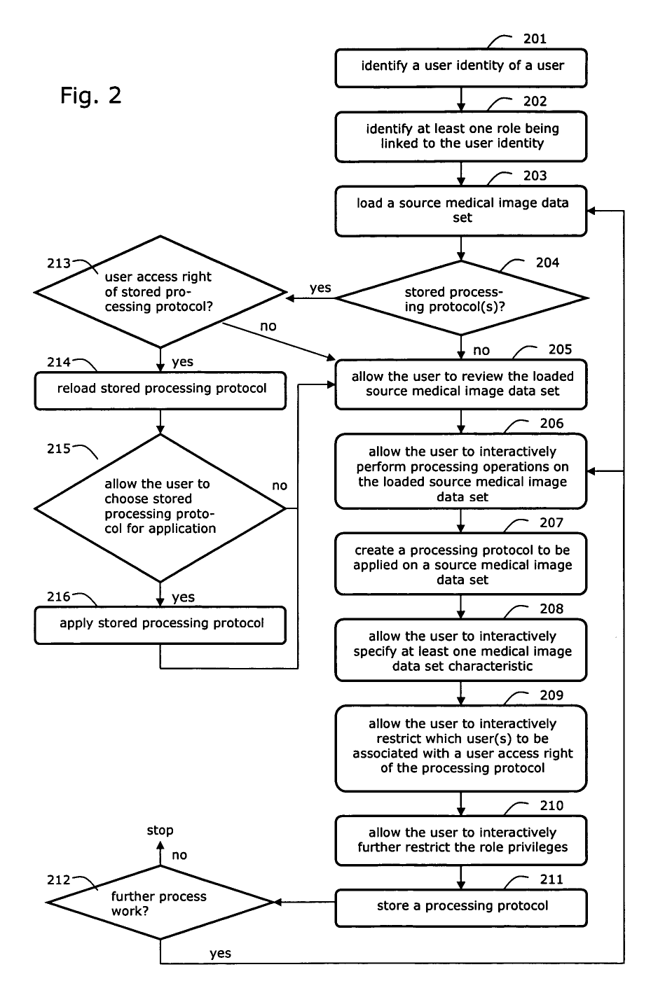

FIG. 2 is a flow diagram representing steps in a process which the computer program product according to a preferred embodiment of the invention is operable to perform. The embodiment of a computer program product according to the present invention shown in FIG. 2 is intended to be used for analysis of a source medical image data set in a medical imaging system 1 and to be implemented either in one analysis workstation 5 or in several analysis workstations 5 in the medical imaging system 1.

In the embodiment shown in FIG. 2, in a first step 201 the computer program product according to the present invention may be operable to identify a user identity of a user, which using the user identity has entered into the medical imaging system 1 at an analysis workstation 5 in which the computer program product according to the present invention is implemented and which intends to utilize the functionality that the computer program product according to the present invention causes the analysis workstation 5 to provide. As previously has been described, each person being entitled to enter into a medical imaging system 1 in which the computer program product according to the present invention is intended to be implemented is assigned a unique user identity to be used for entry into the medical imaging system 1. In the first step 201 that unique user identity of a user intending to utilize the computer program product according to the present invention is identified.

In a second step 202 of the embodiment represented in FIG. 2 the computer program product according to the present invention may be operable to identify at least one role being linked to the user identity identified in the first step 201 from a list of a plurality of roles being implemented in the medical imaging system 1, whereby each role may be associated with a specification of role privileges of performing processing operations on a source medical image data set. As previously has been described, the specification of role privileges of performing processing operations on a source medical image data set is a specification of which processing operation(s) a user identity being linked to the role is entitled to perform. Thus, in the second step 202 the role(s) of a user is/are identified as well as the role privileges associated with the user identity of the user of performing processing operations on a source medical image data set.

In a third step 203 the embodiment of a computer program product according to the present invention represented in FIG. 2 is operable to load a source medical image data set into the analysis workstation 5 from which the load is requested. The user may request that a certain source medical image data set is loaded by specifying the unique identifier of the source medical image data set to be loaded. The source medical image data set to be loaded may, for example, be stored in a file archive 7 within the first hospital component 2 and the analysis workstation 5 from which the load is requested may also be included in the first hospital component 2. Then, the requested source medical image data set may be transferred from the file archive 7 through at least one file server 6 to the analysis work station 5 over the local area network in the first hospital component 2. Of course a corresponding transfer of a data set may be performed if both the analysis workstation 5 from which the load was requested and the source medical image data set are included in the second hospital component 3. However, the source medical image data set to be loaded may also, for example, be stored at a file archive 7 within the first hospital component 2, whereas the analysis workstation 5 from which the load is requested may be included in the second hospital component 3. Then the requested source medical image data set is transferred from the file archive 7 through at least one file server 6 in the first hospital component 2 to the analysis workstation 5 in the second hospital component 3 over the respective local area networks in each of the hospital components 2, 3 as well as the wide area network interconnecting the two hospital components 2, 3. Of course a corresponding transfer of a data set is performed if the source medical image data set is stored in the second hospital component 3 and the analysis workstation 5 from which the request was loaded is included in the first hospital component 2.

In a fourth step 204 the embodiment of a computer program product according to the present invention as represented in FIG. 2 determines whether any stored processing protocol(s) is/are associated with the loaded source medical image data set. The processing protocol will be further described below.

If there are no stored processing protocol(s) this embodiment of the computer program product according to the present invention is in a fifth step 205 operable to allow the user to review the loaded source medical image data set on a screen display of the analysis workstation 5 into which it has been loaded. After a source medical image data set has been loaded into an analysis workstation 5 it may be reviewed by a user before any further processing of the source medical image data set is performed.

In a sixth step 206 this embodiment of the computer program product according to the present invention is operable to allow the user to, based on the role privileges associated with the user identity of performing processing operations on the source medical image data set, interactively perform processing operations on a loaded source medical image data set. Usually, it is necessary to, at least to some extent, process a source medical image data set before an appropriate representation of the data set is obtained such that any findings, which, for example, may be used for diagnosis, surgery planning, treatment and post-operative evaluation, may be determined. The user may in the sixth step 206 work on the loaded source medical image data set by performing one or several processing operations on the loaded source medical image data set for interpretation, manipulation and visualization of the loaded source medical image data set. Computer program products intended to be implemented at one analysis workstation 5 or several analysis workstations 5 in the medical imaging system 1 that causes the analysis workstation(s) 5 to provide the functionality of performance of processing operations are previously well-known and are intended to be used in association with the computer program product according to the present invention for providing the functionality of performance of processing operations. As used herein the term “processing operation” is meant to include any operation performed on a source medical image data set for interpretation, manipulation and/or visualization of the source medical image data set. If the source medical image data set is a 3-D data set, processing operations performed on the source medical image data set in the sixth step 206 may include the manipulation processes employed in deriving an appropriate 2-D image from the source medical image data set. Examples of processing operations are setting viewing direction, setting a color scheme, setting multi-planar reformatting parameters, measurement, clipping, cropping, sculpting, setting of graphical user interface, storing medical image data sets and inserting annotation. A proper color scheme may be set in order to enhance the view of a specific organ. Proper multi-planar reformatting (MPR) parameters may be set in order to expose pathological areas. Anatomy that occludes the target area may be clipped away. Various measurements in the data set may be performed in order to provide quantitative information. Annotation may include indications of findings and identification markings of pathological areas. The processing operations the user is entitled to perform in step 206 is based on the role privileges associated with the user identity.

In the embodiment shown in FIG. 2, in a seventh step 207 the computer program product according to the present invention is operable to create a processing protocol including at least one processing parameter set corresponding to at least a subset of processing operations performed on a loaded source medical image data set. As will be described further below, the processing protocol may be stored in the medical imaging system 1. Upon performance of processing operations on a source medical image data set, it is usually necessary to perform several processing operations before an appropriate representation of the data set is obtained such that any findings can be made. Furthermore, many processing operations are complex to perform. Due to the fact that the processing operations that have to be performed often are numerous and complex, it is usually rather time-consuming to generate an appropriate representation of a particular data set. In order to avoid time-consuming repetitive work, it is usually highly desirable to be able to store information of the manipulation processes employed on a source medical image data set for later self reference, but also for sharing with other users in a collaborative environment.

In the seventh step 207 detailed information such as parameter sets corresponding to performed processing operations may be inserted into a processing protocol. Thereafter, the processing protocol may include at least one parameter set corresponding to at least a subset of processing operations performed on a loaded source medical image data set. Depending on which processing operations that have been performed on a source medical image data set, the processing parameter set may be any parameter set in the group of: viewing direction parameter set, color scheme parameter set, multi-planar reformatting parameter set, measurement parameter set, clipping parameter set, cropping parameter set, sculpting parameter set, parameter set for graphical user interface setting, and annotation and parameter set of storage of medical image data set. Furthermore the processing protocol may include a report of findings and instructional information.

In an eighth step 208 the computer program product according to the embodiment of the present invention shown in FIG. 2 is operable to allow the user to interactively specify at least one medical image data set characteristic to be associated with a processing protocol associater in the processing protocol. The processing protocol associater associates the processing protocol with source medical image data set(s) and associates the processing protocol to each source medical image data set having at least one of the at least one specified medical image data set characteristic. Thus, the processing protocol is associated with each source medical image data set having at least one of the at least one specified medical image data set characteristic and may be applied on any of those source medical image data sets. One or several medical image data set characteristics may be specified in each processing protocol, whereby each processing protocol may be associated with one or several source medical image data sets. If more than one medical image data set characteristic may be specified in a processing protocol, they may be combined using the logical operator AND or the logical operator OR. For example, if two medical image data set characteristics are specified in a processing protocol and the processing protocol is to be applied on a source medical image data set having both specified medical image data set characteristics, the logical operator AND is used. If two medical image data set characteristics are specified in a processing protocol and the processing protocol is to be applied on a source medical image data set having at least one of the specified medical image data set characteristics, the logical operator OR is used.

The medical image data set characteristic may, for example, be a unique identifier of a source medical image data set. The unique identifier of a source medical image data set may, for example, be the unique identification number that, as mentioned above, each acquired source medical image data set preferably is assigned. If one or several such unique identification numbers are specified to be associated with the processing protocol associater, the processing protocol may be limited to only being applied on the source medical image data set being assigned that specified unique identification number or on those source medical image data sets being assigned those specified unique identification numbers and is then thus data set specific. A data set specific processing protocol may, depending on the user access rights of the processing protocol which will be described below, be applied by the same user that created it when the user wants to restore a previously derived appropriate representation of a source medical image data set or by other users too in a collaborative environment. A lot of repetitive work is avoided due to the ability to use detailed information of performed processing operations in a processing protocol.

Furthermore, the medical image data set characteristic may also be a data type characteristic, which is an indication of the type of a data set. The data type characteristic may be any characteristic included in the group of: a characteristic representing the acquisition device used for collecting a source medical image data set, a characteristic representing the image object of which a source medical image data set is an image data representation and a characteristic representing the examination type.

If one or several of the above mentioned data type characteristics are specified to be associated with the processing protocol associater, the processing protocol may be limited to being applied on source medical image data sets having that or those data type characteristic(s). The processing protocol is then data type specific. Such a processing protocol may, depending on the user access rights of the processing protocol which will be described below, be used only by the user that created it or by several users in a collaborative environment.

For example, on source medical image data sets acquired by the same acquisition device, the same visualization parameters may sometimes be used. A lot of repetitive work will then be avoided if the visualization parameters are included in a processing protocol, which may be applied on all source medical image data sets acquired by the same acquisition device. Furthermore, the same view direction parameters and volume clipping parameters may sometimes be applied on examinations of a certain body part. A lot of repetitive work will also be avoided then, if the view direction parameters and volume clipping parameters are included in a processing protocol, which may be applied on all source medical image data sets of the certain body part.

In a ninth step 209 of the embodiment represented in FIG. 2 the computer program product according to the present invention is operable to allow the user to interactively restrict which user(s) to be associated with a user access right of the processing protocol by specifying which role(s) or which user identity/identities to be associated with the user access right. Thus, in this step 209 the user may choose which other users that are entitled to have access to the processing protocol by, for example, choosing which role(s) that are entitled to have access to the processing protocol. The processing protocol may then be accordingly role specific. All users having user identities being linked to the chosen roles are then associated with a user access right of the processing protocol and may thus then use the processing protocol.

However, the user may instead of choosing which role(s) that are entitled to have access to the processing protocol, choose which user identity/identities that are entitled to have access to the processing protocol. The processing protocol may then be accordingly user specific. All users having any of the chosen user identities may then be associated with a user access right of the processing protocol and may thus use the processing protocol. Users being associated with an access right of the processing protocol may apply the processing protocol on the source medical image data set to restore a previously made representation of a source medical image data set. However, users having user identities not being associated with a user access right of the processing protocol may not use the processing protocol and the processing protocol may thus be hidden for those users. For example, a clinician having elaborated a processing protocol for treatment planning may wish to hide the processing protocol for radiologists.

In a tenth step 210 of the embodiment shown in FIG. 2 the computer program product according to the present invention is operable to allow the user to interactively further restrict the role privileges of performing processing operations. As mentioned above, each role may be associated with a specification of role privileges of performing processing operations on a source medical image data set. However, in the tenth step 210, the role privileges may be further restricted. The further restricted role privileges are to be applied in association with the processing protocol, i.e. when the processing protocol is applied on a source medical image data set the restricted role privileges are the effective privileges of performing processing operations.

The eighth, ninth and tenth steps 208-210 of the embodiment illustrated in FIG. 2 may only be performed on a stored processing protocol by the user that elaborated the processing protocol or by “super-users”. Thus, the specified medical image data set characteristic(s) to be associated with a processing protocol associater, the specified role(s) or user identity/identities being associated with a user access right of the processing protocol and/or the further restricted role privileges may only be changed in a stored processing protocol by the user that elaborated the processing protocol or by “super-users”. Information included in a stored processing protocol may not be changed by other users than the user that elaborated the processing protocol or by “super-users”, which implies for a high reliability of the analysis process when the computer program product according to the present invention is used. Furthermore, a stored processing protocol may not be removed by any other users than the user that elaborated the processing protocol or by “super-users”, which implies that a stored processing protocol may not be accidentally removed by any user not being entitled to remove the stored processing protocol.

In an eleventh step 211 of the embodiment in FIG. 2 the computer program product according to the present invention is operable to store the processing protocol in a central unit in the medical imaging system for enabling transfer within the entire medical imaging system 1. The central unit may for example be a file system, which, for example, may be located within the file server 6. The processing protocol is preferably stored as a file conforming to a standard file format such that it may be transmitted and used unimpeded within the medical imaging system 1 as well as transmitted to other medical imaging systems. Furthermore, the processing protocol may be stored in such a way that it may be applied on a source medical image data set for automatic execution of the processing operations stored in the processing protocol. A data set specific processing protocol may be stored as a bookmark and a data type specific processing protocol may be stored as a preset. Since only the processing protocol is stored and not the derived representation of a source medical image data set, data storage resources are saved.

When a user has derived an appropriate representation of a source medical image data set, a processing protocol may thus be created and stored, whereby information of the performed processing work is stored and the appropriate representation may later be restored by application of the processing protocol on the source medical image data set. Therefore, there may be no need to store a derived appropriate representation of a medical image data set, but the processing protocol is intended to be applied on a source medical image data set for restore of a previously made appropriate representation. Depending on the specified medical image data set characteristic(s), a stored processing protocol might be possible to apply not only on the source medical image data set on which it was elaborated, but also on other source medical image data sets. Furthermore, depending on the user access rights of the processing protocol, other users than the user that elaborated the processing protocol might be entitled to use the processing protocol for execution of the processing operations stored in the processing protocol.

In a twelfth step 212 of the embodiment illustrated in FIG. 2 the user may stop the processing work or may continue the processing work and load the same source medical image data set again or another source medical image data set.

If the computer program product in the fourth step 204 determines that there are one or several stored processing protocols associated with the loaded source medical image data set, the computer program product determines in a thirteenth step 213 whether the user identity identified in the first step 201 is associated with a user access right of the stored processing protocol(s) associated with the loaded source medical image data set. If the user identity is not associated with a user access right of any of the stored processing protocols associated with the loaded source medical image data set, the user may not use the stored processing protocol(s) and then the stored processing protocols(s) is/are not reloaded. However, the computer program product may then be operable to, according to the fifth step 205, allow the user to review the loaded source medical image data set and then, based on the role privileges, perform processing work on the loaded source medical image data set according to the steps 206-211. Thereby the user may elaborate an own processing protocol. However, if the user identity is associated with a user access right of any of the processing protocols, the computer program product is in a fourteenth step 214 operable to reload that/those processing protocol(s). For each reloaded processing protocol a thumbnail image of a result of application of respective processing protocol on the loaded source medical image data set may then, for example, appear on the screen display at the analysis workstation 5.

In a fifteenth step 215 of the embodiment shown in FIG. 2 the computer program product is operable to allow the user to interactively choose a reloaded processing protocol for application on the loaded source medical image data set. If none of the reloaded processing protocol(s) is chosen to be applied on the loaded source medical image data set, the computer program product is operable to, according to the fifth step 205, allow the user to review the loaded source medical image data set and then, based on the role privileges, perform processing work on the loaded source medical image data set according to the steps 206-211. Thereby the user may elaborate an own processing protocol. However, if a reloaded processing protocol is chosen to be applied on a loaded source medical image data set, the computer program product is in a sixteenth step 216 operable to apply the reloaded processing protocol on the loaded source medical image data set. A representation of the source medical image data set is then automatically derived according to the processing protocol. Thereafter the computer program product may be operable to, according to the fifth step 205, allow the user to review the loaded source medical image data set, i.e. with the reloaded processing protocol applied on the source medical image data set. Then, the computer program product may be operable to, based on the further restricted role privileges, allow the user to perform further processing work on the loaded source medical image data set according to the steps 206-211. If a user performs any further processing work, then a second processing protocol may be created and stored according to the steps 206-211. The second processing protocol may include then the parameter set(s) included in the reloaded and applied processing protocol as well as at least one parameter set corresponding to at least a subset of processing operations performed during the further processing work. In order to later restore the representation of the source medical image data set obtained after the further processing work, the second processing protocol may be applied on the source medical image data set.

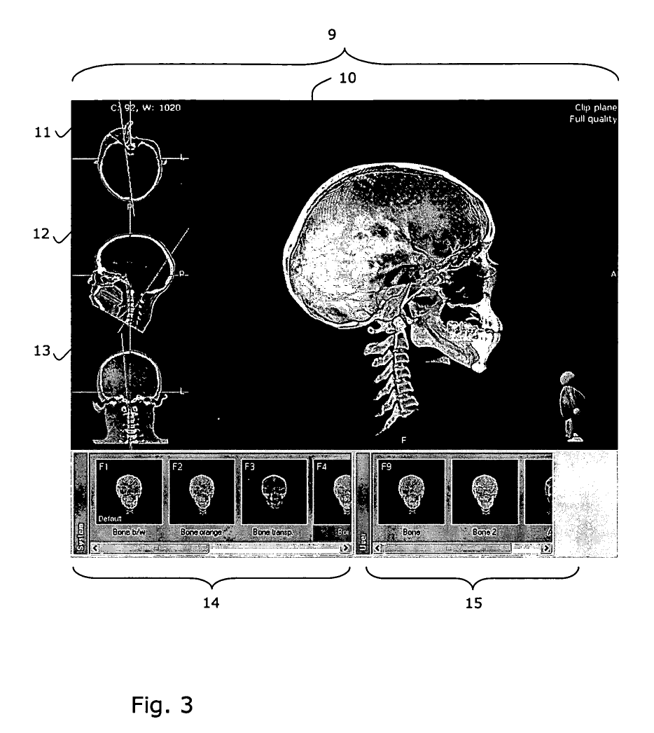

FIG. 3 shows an example of a screen shot of a display 9 including a 2D image 10 generated form a 3D source medical image data set and an axial section 11, a sagittal section 12 and a coronal section 13 of the 3D source medical image data set for assisting diagnostic interpretation. At the lower part of the display 9 stored processing protocols, two sets of color presets, associated with the source medical image data set are shown. One of the color presets is a system color preset 14 accessible by all users and the other color preset is a user specific color preset 15. The user may choose to apply any of these presets 14, 15 on the source medical image data set. In the screen shot, the user has worked on the source medical image data set and has performed processing operations such as clipping, annotation and measurement.

According to the above, upon use of the computer program product according to the invention, the elaborated processing protocol may be chosen to be data set specific or data type specific. In the data set specific case the processing protocol may be applied on the specified data set(s) only. In the data type specific case, the processing protocol may be applied on data set(s) of the specified type(s) only. Furthermore, the elaborated processing protocol may be chosen to be role specific or user specific. In the user specific case, the processing protocol may be used by one or several specified users only. In the role specific case, the processing protocol may be used by one or several users having user identities being linked to one or several specified roles. Thus, the elaborated processing protocol may be chosen to be any of the combinations of: data set specific and user specific, data set specific and role specific, data type specific and user specific or data type specific and role specific. The ability of a user to interactively set the processing protocol to be any of those four combinations may be highly advantageous for achieving a high reliability of the analysis process, i.e. for minimizing the sources of error. These combinations will be further described in the examples of application of the present invention below.

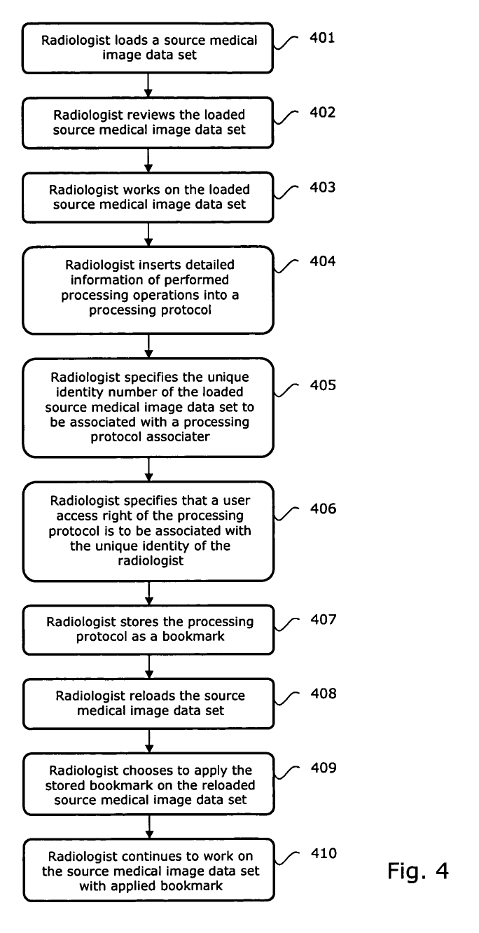

FIG. 4 is a flow diagram representing an embodiment of a data set specific and user specific application of the present invention. In a first step 401 a radiologist may load a source medical image data set of interest into an analysis workstation 5. The radiologist may review the loaded source medical image data set on a screen display of the analysis workstation 5 in a second step 402 and may work on the loaded source medical image data set in a third step 403 by performing processing operations on the loaded source medical image data set. The processing operations that the radiologist is entitled to performed may be determined by the role privileges associated with the role of the radiologist. For example, the radiologist role may be associated with an entitlement of performing the following processing operations: defining color transfer function, setting MPR parameter, and performing annotation and measurements. Detailed information of performed processing operations, i.e. at least one processing parameter set corresponding to performed processing operations, may be inserted into a processing protocol in a fourth step 404. For example, if a new color scheme has been set, a parameter set corresponding to the new color scheme may be inserted into the processing protocol. In a fifth step 405 the radiologist may specify the unique identity number of the loaded source medical image data set to be associated with a processing protocol associater, whereby the processing protocol may be linked to that source medical image data set. In a sixth step 406 the radiologist may specify that a user access right of the processing protocol is to be associated with the unique identity of the radiologist. Then the radiologist may store the processing protocol as a bookmark in a central unit in a seventh step 407. When the radiologist later wants to restore the previously derived representation, the radiologist may reload the source medical image data set into an analysis work station 5 in an eighth step 408, whereby the stored bookmark associated with the reloaded source medical image data set also may be loaded into the analysis workstation 5 and a thumbnail image of a result of application of the bookmark on the source medical image data set may appear on the screen display. In a ninth step 409 the radiologist may choose to apply the bookmark on the reloaded source medical image data set to restore the previously derived representation. In a tenth step 410 the radiologist may continue to work on the source medical image data set with applied bookmark. Thus, at this application the stored processing protocol may only be applied on the source medical image data set on which it was elaborated and only the radiologist who elaborated the processing protocol is entitled to use it.

A data set specific and user specific application may, for example, be advantageous to use when the user that elaborates a processing protocol does not want to share the processing protocol with other users and finds the processing protocol applicable only on the source medical image data set on which it was elaborated. Then the processing protocol may be hidden for all other users than the user who elaborated the processing protocol. Furthermore, a data set specific and user specific application may also, for example, be advantageous when the processing protocol is to be shared by a few users having the same role. For example, if two radiologists are to collaborate during analysis of a source medical image data set it may be advantageous if those two radiologists, and only those two radiologists, are entitled to use the processing protocol.

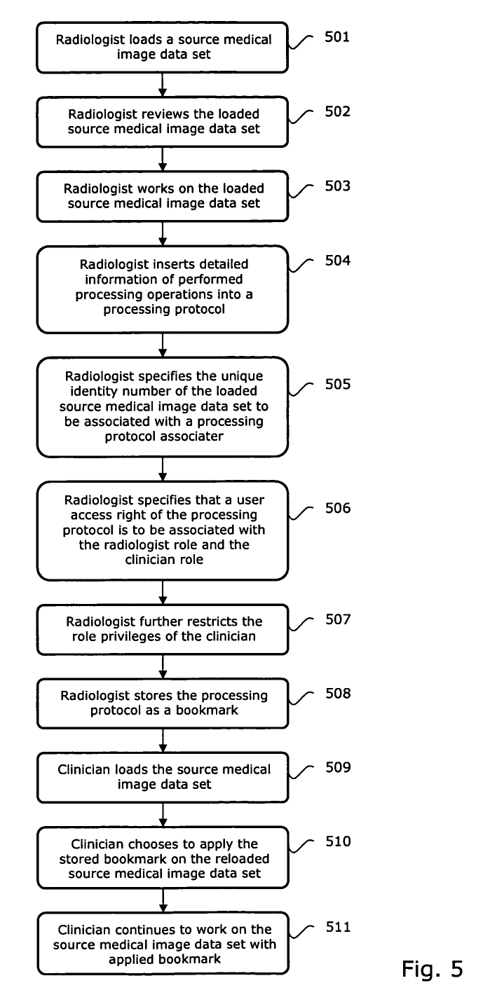

FIG. 5 is a flow diagram representing an embodiment of a data set specific and role specific application of the present invention. In a first step 501 a radiologist may load a source medical image data set of interest into an analysis workstation 5. The radiologist may review the loaded source medical image data set on a screen display of the analysis workstation 5 in a second step 502 and may work on the loaded source medical image data set in a third step 503 by performing processing operations on the loaded source medical image data set. The processing operations that the radiologist is entitled to performed may be determined by the role privileges associated with the role of the radiologist. Detailed information of performed processing operations, i.e. at least one processing parameter set corresponding to performed processing operations, may be inserted into a processing protocol in a fourth step 504. In a fifth step 505 the radiologist may specify the unique identity number of the loaded source medical image data set to be associated with a processing protocol associater, whereby the processing protocol is associated with that source medical image data set. In a sixth step 506 the radiologist may specify that a user access right of the processing protocol is to be associated with the radiologist role and the clinician role. The processing operations that the clinician is entitled to perform in the medical imaging system 1 may be determined by the role privileges associated with the role of the clinician. For example, the clinician role may be associated with an entitlement of performing the following processing operations: changing viewing direction, applying predefined color schemes, performing measurements and adding annotations. However, in a seventh step 507, the radiologist may further restrict the role privileges of the clinician, which further restricted role privileges are to be applied when the processing protocol is used. Then the radiologist may store the processing protocol as a bookmark in a central unit in an eighth step 508. In a ninth step 509 a clinician may load the source medical image data set into an analysis workstation 5. Since the clinician may be associated with a user access right of the stored bookmark associated with the source medical image data set, the stored bookmark may also be loaded into the analysis workstation 5 and a thumbnail image of a result of application of the bookmark on the loaded source medical image data set appears on the screen display. In a tenth step 510 the clinician may choose to apply the stored bookmark on the source medical image data set to restore the previously derived representation. In an eleventh step 511 the clinician may continue to work on the source medical image data set with applied bookmark, whereby the guilty role privileges are the further restricted role privileges. Thus, at this application the stored processing protocol may only be applied on the source medical image data set on which is/was elaborated and only users having user identities being linked to the radiologist role or clinician role are entitled to use it.

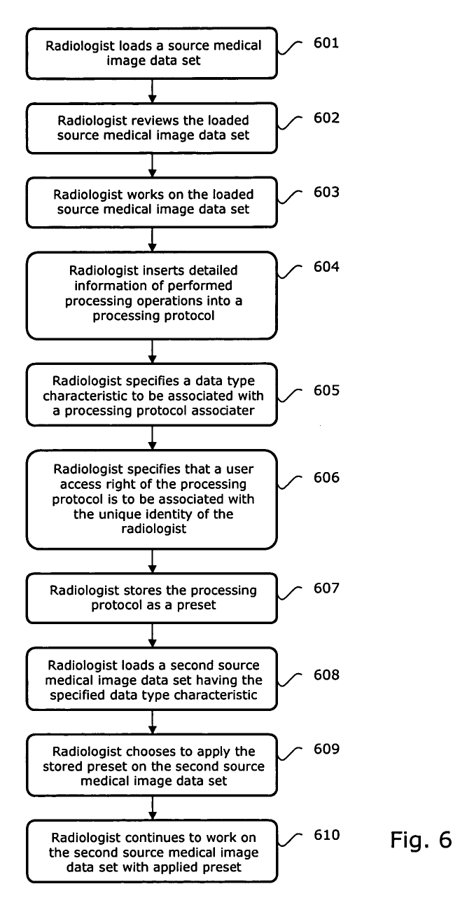

A data set specific and role specific application may, for example, be advantageous to use when a source medical image data set is to be analysed by users having different roles in a “chain” of users. Such a “chain” may, for example, include a technician, a radiologist and a clinician. Each of the users in the chain may then elaborate a processing protocol to be used by the users later in the chain. Furthermore, each of the users may also further restrict the role privileges of the roles of the users later in the chain based on what the user that elaborates the processing protocol thinks is appropriate for this specific processing protocol in order to achieve a high reliability of the analysis process. FIG. 6 is a flow diagram representing an embodiment of a data type specific and user specific application of the present invention. In a first step 601 a radiologist may load a source medical image data set of interest into an analysis workstation 5. The radiologist may review the loaded source medical image data set on a screen display of the analysis workstation 5 in a second step 602 and may work on the loaded source medical image data set in a third step 603 by performing processing operations on the loaded source medical image data set. The processing operations that the radiologist is entitled to performed may be determined by the role privileges associated with the role of the radiologist. Detailed information of performed processing operations, i.e. at least one processing parameter set corresponding to performed processing operations, may be inserted into a processing protocol in a fourth step 604. In a fifth step 605 the radiologist may specify a data type characteristic to be associated with a processing protocol associater, whereby the processing protocol may be associated with source medical image data sets having that data type characteristic. In a sixth step 606 the radiologist may specify that a user access right of the processing protocol is to be associated with the unique identity of the radiologist. Then the radiologist may store the processing protocol as a preset in a central unit in a seventh step 607. When the radiologist loads a second source medical image data set having the specified data type characteristic into an analysis work station 5 in an eighth step 608, the stored preset may also be loaded into the analysis workstation 5 and a thumbnail image of a result of application of the preset on the second source medical image data set may appear on the screen display. In a ninth step 609 the radiologist may choose to apply the preset on the second source medical image data set. In a tenth step 610 the radiologist may continue to work on the second source medical image data set with applied preset. Thus, at this application the stored processing protocol may only be applied on source medical image data sets having the specified data type characteristic and only the radiologist who elaborated the processing protocol may be entitled to use it.

A data type specific and user specific application may, for example, be advantageous to use when a processing protocol is appropriate to use as a preset for many source medical image data sets of the same type and when only one or a few users are to be associated with a user access right of the processing protocol.

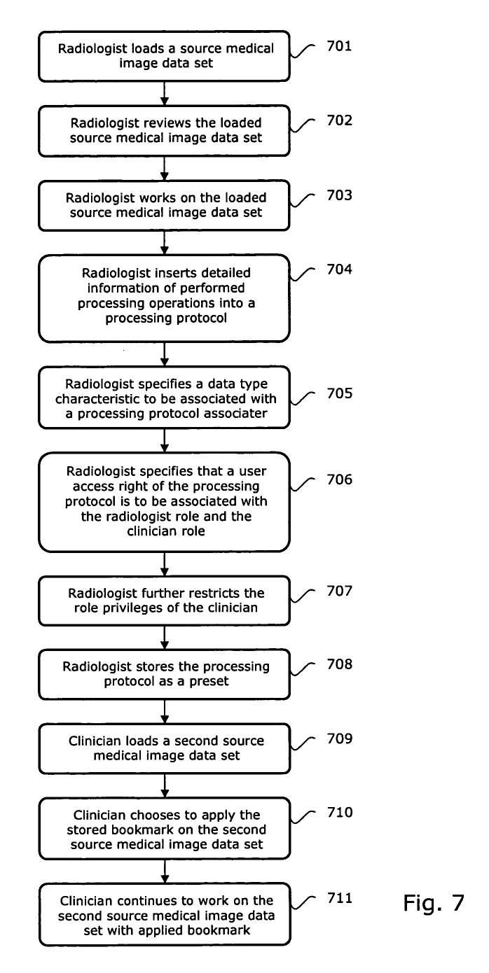

FIG. 7 is a flow diagram representing an embodiment of a data type specific and role specific application of the present invention. In a first step 701 a radiologist may load a source medical image data set of interest into an analysis workstation 5. The radiologist may review the loaded source medical image data set on a screen display of the analysis workstation 5 in a second step 702 and may work on the loaded source medical image data set in a third step 703 by performing processing operations on the loaded source medical image data set. The processing operations that the radiologist is entitled to performed may be determined by the role privileges associated with the role of the radiologist. Detailed information of performed processing operations, i.e. at least one processing parameter set corresponding to performed processing operations, may be inserted into a processing protocol in a fourth step 704. In a fifth step 705 the radiologist may specifiy a data type characteristic to be associated with a processing protocol associater, whereby the processing protocol may be associated with source medical image data sets having that data type characteristic. In a sixth step 706 the radiologist may specify that a user access right of the processing protocol is to be associated with the radiologist role and the clinician role. The processing operations that the clinician is entitled to perform in the medical imaging system 1 may be determined by the role privileges associated with the role of the clinician. However, in a seventh step 707, the radiologist may further restrict the role privileges of the clinician, which further restricted role privileges are to be applied when the processing protocol is used. Then the radiologist may store the processing protocol as a preset in a central unit in an eighth step 708. In a ninth step 709 a clinician may load a second source medical image data set having the specified data type characteristic into an analysis workstation 5. Since the clinician is associated with a user access right of the stored preset associated with the second source medical image data set, the stored preset may also be loaded into the analysis workstation 5 and a thumbnail image of a result of application of the preset on the second source medical image data set appears on the screen display. In a tenth step 710 the clinician may choose to apply the preset on the second source medical image data set. In an eleventh step 711 the clinician may continue to work on the second source medical image data set with applied preset, whereby the guilty role privileges may be the further restricted role privileges. Thus, at this application the stored processing protocol may only be applied on source medical image data sets having the specified data type characteristic and only users having user identities being linked to the radiologist role or clinician role are entitled to use it.

A data type specific and role specific application may, for example, be advantageous to use when a processing protocol is appropriate to use as a preset for many source medical image data sets of the same type and users having different roles are to be associated with a user access right of the processing protocol.

Thus, while there have been shown and described and pointed out fundamental novel features of the invention as applied to embodiments thereof, it will be understood that various omissions and substitutions and changes in details of the methods described, and in their operation, may be made by those skilled in the art without departing from the spirit of the invention. For example, it is expressly intended that all combinations of those method steps and/or system elements which perform substantially the same function in substantially the same way to achieve the same results are within the scope of the invention. Moreover, it should be recognized that method steps and/or system elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A computer program product for analysis of a source medical image data set in a medical imaging system, the computer program product being operable to:
identify a user identity of a user;
identify at least one role being linked to said user identity from a list of a plurality of roles, each role being associated with a specification of role privileges of performing processing operations on a source medical image data set;
load a source medical image data set into an analysis workstation in said medical imaging system;
allow said user to review said loaded source medical image data set;
allow said user to, based on said role privileges, interactively perform processing operations on said loaded source medical image data set;
create a processing protocol comprising at least one processing parameter set corresponding to at least a subset of processing operations performed on said loaded source medical image data set;
allow said user to interactively specify at least one medical image data set characteristic to be associated with a processing protocol associater in said processing protocol, said processing protocol being associated with each source medical image data set having at least one of the at least one specified medical image data set characteristic;
allow said user to interactively restrict which users to be associated with a user access right of said processing protocol by specifying which roles or which user identity/identities to be associated with said user access right;
allow said user to interactively further restrict said role privileges of performing processing operations, which further restricted role privileges are to be applied in association with said processing protocol;
store said processing protocol in a central unit in the medical imaging system, and
if said user is associated with a user access right of a stored processing protocol associated with said loaded source medical image data set
reload said stored processing protocol into an analysis workstation in said medical imaging system;
allow said user to interactively choose said processing protocol for application on said loaded source medical image data set, and
apply said stored processing protocol on said loaded source medical image data set.

2. The computer program product according to claim 1, wherein said medical imaging system comprises a picture archiving and communication system.

3. The computer program product according to claim 1, wherein said central unit is a file system.

4. The computer program product according to claim 1, wherein said list of roles comprises at least one of: technician, radiologist and clinician.

5. The computer program product according to claim 1, wherein said specification of role privileges of performing processing operations on a source medical image data set is a specification of which processing operations that a user identity being linked to the role is entitled to perform.

6. The computer program product according to claim 1, wherein said processing operation is any operation selected from the group comprising: setting viewing direction, setting a color scheme, setting multi-planar reformatting parameters, measurement, clipping, cropping, sculpting, setting of graphical user interface, storing medical image data sets and inserting annotation.

7. The computer program product according to claim 1, wherein said processing parameter set is any parameter selected from the group comprising: viewing direction parameter set, color scheme parameter set, multi-planar reformatting parameter set, measurement parameter set, clipping parameter set, cropping parameter set, sculpting parameter set, parameter set for graphical user interface setting, annotation and parameter set of storage of medical image data sets.

8. The computer program product according to claim 1, wherein said source medical image data set is a volume data set.

9. The computer program product according to claim 1, wherein said source medical image data set is of DICOM format.

10. The computer program product according to claim 1, wherein said medical image data set characteristic is a unique identifier of a source medical image data set.

11. The computer program product according to claim 10, wherein one medical image data set characteristic is specified and wherein said medical image data set characteristic is the unique identifier of the source medical image data set on which said processing protocol is elaborated.

12. The computer program product according to claim 10, wherein said processing protocol is stored as a bookmark.

13. The computer program product according to claim 1, wherein said medical image data characteristic is a data type characteristic comprised in the group comprising: a characteristic representing an acquisition device, a characteristic representing an image object and a characteristic representing the examination type.

14. The computer program product according to claim 13, wherein said processing protocol is stored as a preset.

15. A method for analysis of a source medical image data set in a medical imaging system, the method comprising:
identifying a user identity of a user;
identifying at least one role being linked to said user identity from a list of a plurality of roles, each role being associated with a specification of role privileges of performing processing operations on a source medical image data set;
loading a source medical image data set into an analysis workstation in said medical imaging system;
allowing said user to review said loaded source medical image data set;
allowing said user to, based on said role privileges, interactively perform processing operations on said loaded source medical image data set;
creating a processing protocol comprising at least one processing parameter set corresponding to at least a subset of processing operations performed on said loaded source medical image data set;
allowing said user to interactively specify at least one medical image data set characteristic to be associated with a processing protocol associater in said processing protocol, said processing protocol being associated with each source medical image data set having at least one of the at least one specified medical image data set characteristic;
allowing said user to interactively restrict which users to be associated with a user access right of said processing protocol by specifying which roles and/or which user identity/identities to be associated with said user access right;
allowing said user to interactively further restrict said role privileges of performing processing operations, which further restricted role privileges are to be applied in association with said processing protocol;
storing said processing protocol in a central unit in the medical imaging system, and
if said user is associated with a user access right of a stored processing protocol associated with said loaded source medical image data set
reloading said stored processing protocol into an analysis workstation in said medical imaging system;
allowing said user to interactively choose said processing protocol for application on said loaded source medical image data set, and
applying said stored processing protocol on said loaded source medical image data set.

16. The method according to claim 15, wherein said medical imaging system comprises a picture archiving and communication system.

17. The method according to claim 15, wherein said central unit is a file system.

18. The method according to claim 15, wherein said list of roles comprises at least one of: technician, radiologist and clinician.

19. The method according to claim 15, wherein said specification of role privileges of performing processing operations on a source medical image data set is a specification of which processing operations that a user identity being linked to the role is entitled to perform.

20. The method according to claim 15, wherein said processing operation is any operation selected from the group comprising: setting viewing direction, setting a color scheme, setting multi-planar reformatting parameters, measurement, clipping, cropping, sculpting, setting of graphical user interface, storing medical image data sets and inserting annotation.

21. The method according to claim 15, wherein said processing parameter set is any parameter set selected from the group comprising: viewing direction parameter set, color scheme parameter set, multi-planar reformatting parameter set, measurement parameter set, clipping parameter set, cropping parameter set, sculpting parameter set, parameter set for graphical user interface setting, annotation and parameter set of storage of medical image data sets.

22. The method according to claim 15, wherein said source medical image data set is a volume data set.

23. The method according to claim 15, wherein said source medical image data set is of DICOM format.

24. The method according to claim 15, wherein said medical image data set characteristic is a unique identifier of a source medical image data set.

25. The method according to claim 24, wherein one medical image data set characteristic is specified and wherein said medical image data set characteristic is the unique identifier of the source medical image data set on which said processing protocol is elaborated.

26. The method according to claim 24, wherein said processing protocol is stored as a bookmark.

27. The method according to claim 15, wherein said medical image data characteristic is a data type characteristic selected from the group comprising: a characteristic representing an acquisition device, a characteristic representing an image object and a characteristic representing the examination type.

28. The method according to claim 27, wherein said processing protocol is stored as a preset.

29. A computer program, which is stored on a computer readable storage media, and which is suitable to perform the method of claim 15 when it is run on a digital computer.

30. A computer program product, which is directly loadable into the internal memory of a digital computer, and which comprises a computer program for performing the method of claim 15 when said program is run on said computer.
